(19) United States
(12) Patent Application Publication
(10) Pub. No.: US 2008/0149468 A1
(43) Pub. Date: Jun. 26, 2008

(54) Reach a lite

(76) Inventor: Rodney Smith, Portales, NM (US)

Correspondence Address: Rodney L. Smith, 1929 Diamond Way, Portales, NM, 88130, US

(21) Appl. No.: 11/644,798

(22) Filed: Dec. 22, 2006

(51) Int. Cl. H01H 3/20

(52) U.S. Cl. 200/331

(57) ABSTRACT

This invention consists of a plastic rod designed to turn a toggle light switch on and off. Dual mounting positions allows anyone to reach different heights when turning on a light switch that may not normally be accessible, such as a child who can not reach the light switch from the top of a bunk bed. With the longer end of the rod facing upward, a person on the top bunk can now turn the light on and off by sliding the rod up or down. Mounted in the opposite direction with the longer end of the rod facing downward, a small child or someone confined to a wheelchair can easily and safely turn the light switch on and off by sliding the rod up or down. The actuating arm has two different lengths, the upper being 8 in. from center, the lower being 15½ in. from center.

### FIELD OF THE INVENTION

The present patents do not have the capability to be used from above and below simultaneously, thus allowing 15½ inches or 8 inches going up or down, depending on the need of the consumer. For instance if a switch is blocked by furniture or an appliance, with the longer end facing upward you can now turn the light switch by grasping the T shaped end and sliding the actuating arm up and down.

### BACKGROUND OF THE INVENTION

A light switch may be inaccessible from above or below for various reasons. The light switch extender is attached in a sliding manner to a switch plate so that in the mounting position with the longer end of the actuating arm going upward, an existing light switch which may not be accessible from the upper bunk of a pair of bunk beds or due to file cabinets or certain types of dressers can easily be accessed by grasping T shaped handle on upper end and sliding actuating arm up or down. With the longer end of the actuating arm going downward this would allow a small child or persons confined to a wheelchair to easily turn the light on or off by sliding the actuating arm up or down.

Numerous wall switch installations have been provided in prior art, for example, U.S. Pat. No. 4,105,884 to Damsky; U.S. Pat. No. 4,454,401 to Powis, Jr.; U.S. Pat. No. 4,914,265 to Mongeau; U.S. Pat. No. 5,577,602 to Conner et. al. and U.S. Pat. No. 6,036,330 to Sanguedolce are all illustrative of such prior art. While these may be suitable for the particular purpose to which the address, they would not be suitable for the purposes of the present invention as heretofore described.

DAMSKY, ARNOLD M

ELECTRICAL TOGGLE SWITCH LEVER EXTENDER

U.S. Pat. No. 4,105,884

A substitute switch cover plate has an elongated opening within which is reciprocally captured. An actuating member having a recessed carrier portion at the inside is adapted to loosely enclose the control lever of an electrical toggle switch. A slide knob at the outside is for moving the carrier member together with the toggle switch lever between on and off position.

POWIS, JR. GEORGE S.

SAFETY EXTENSION LEVER FOR WALL SWITCH

U.S. Pat. No. 4,454,401

A modified wall plate for a standard toggle switch outlet is equipped with an arm or a lever adapted to slide on the plate. The arm or lever is provided with a hollowed protuberance extending outwardly from the front face of the arm and arranged to receive and enclose the actuating finger of a standard toggle switch with a detachable rod extending to a substantial distance below the bottom of the wall plate to a level within reach of a small child, thus enabled to safely operate the switch.

MONGEAU, FRANCOIS

EXTERIOR COVER FOR AN ELECTRICAL SOCKET OR SWITCH

U.S. Pat. No. 4,914,265

New cover assemblies for electrical fixtures in buildings allow conventional outlet and toggle light switches to be cheaply converted into a variety of different color designs and/or colors without changing the electrical infrastructure of the fixture. The cover assemblies are comprised of a cover plate with an appropriate number of orifices being covered by a slider, so that the whole cover assembly shields the conventional parts of the fixtures normally visible in building interiors.

CONNER, GLENN C.

RAPOZA, MARTIN J.

PERRY, SCOTT M.

SWITCH PLATE EXTENDER APPARATUS

U.S. Pat. No. 5,577,602

A switch extender for electrical switches having a slideable front plate coupled to a back plate which in turn is attached to a wall mounted switch plate. The back plate has a knock out portion which allows use of the invention with both toggle and rocker switches. A pair of cylindrical bars is positioned within an opening in the front plate. A toggle switch fits within a slot between the bars, and the corners of the rocker switch fit within slots, outside of the bars on the front plate. Sliding the front plate relative to the back plate actuates the switch

SANGUEDOLCE, MICHAEL

LIGHT SWITCH EXTENDER

U.S. Pat. No. 6,036,330

A light switch extender comprising an elongated actuator in an assembly that is vertically mounted to slide over a switch plate of a light switch located in a junction box in the wall. The elongated actuator encases a lever of the light switches and extends downwardly therefrom. A small child who normally may not be able to reach the lever of the light switch can now operate the lever of the light switch between an on and off posistion, by sliding the elongated actuator up or down.

The present patents do not have the capability to be used from above and below simultaneously, thus allowing 15½ inches or 8 inches going up or down, depending on the need of the consumer. For instance if a switch is blocked by furniture or an appliance, with the longer end facing upward you can now turn the light switch by grasping the T shaped end and sliding the actuating arm up and down.

It is therefore an object of the invention to provide a light switch extender that will overcome the shortcomings of the prior art devices.

A second object is to provide a light switch extender that is attached in a sliding manner to a switch plate, so that a small child or persons confined to a wheelchair can safely and conveniently operate the lever of a light switch.

Another object is to provide an actuating arm with one end of the arm being longer than the other thus allowing for the mounting to be reversed therefore allowing a light switch to be turned to the on and off position from the top bunk of a set of bunk beds or a switch which might otherwise be blocked by file cabinets or other furniture.

Another object is to provide a light switch extender that is easily installed.

A further object is to provide a light switch extender that is easily operated.

A still further object is to provide a light switch that is economical in cost and manufacturing.

Further objects of the above related object, this invention may be embodied in the form illustrated in the accompanying drawings, attention being called to the fact, however, that the drawings are illustrations only, and that changes may be made in the specific construction illustrated and described with in the scope of the appended claims.

### SUMMARY OF THE INVENTION

This invention consists of a plastic rod which is designed to turn a toggle light switch on and off. Dual mounting positions allow you to reach different heights when turning on a light switch that may not normally be accessible, such as a child who can not reach the light switch from a top bunk, with the longer end of the rod facing upward a person on the top bunk on a set of bunk beds can now turn the light on and off by sliding the rod up or down. Mounted in the opposite direction with the longer end of the rod facing downward a small child or someone confined to a wheelchair can easily and safely turn the light switch on and off by sliding the rod up or down.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a front elevation view of a front elevational view of actuating arm; and

FIG. 2 is a right exploded view of a side elevational view of actuating arm taking in the direction of arrow 1b in FIG. 1 and a perspective view of the wall switch and the junction box the switch plate in phantom and screws exploded therefrom.

For purposes of clarity and brevity, like elements and components will bear the same designations and numbering throughout the Figures.

### DESCRIPTION OF THE PREFERRED EMBODIMENT

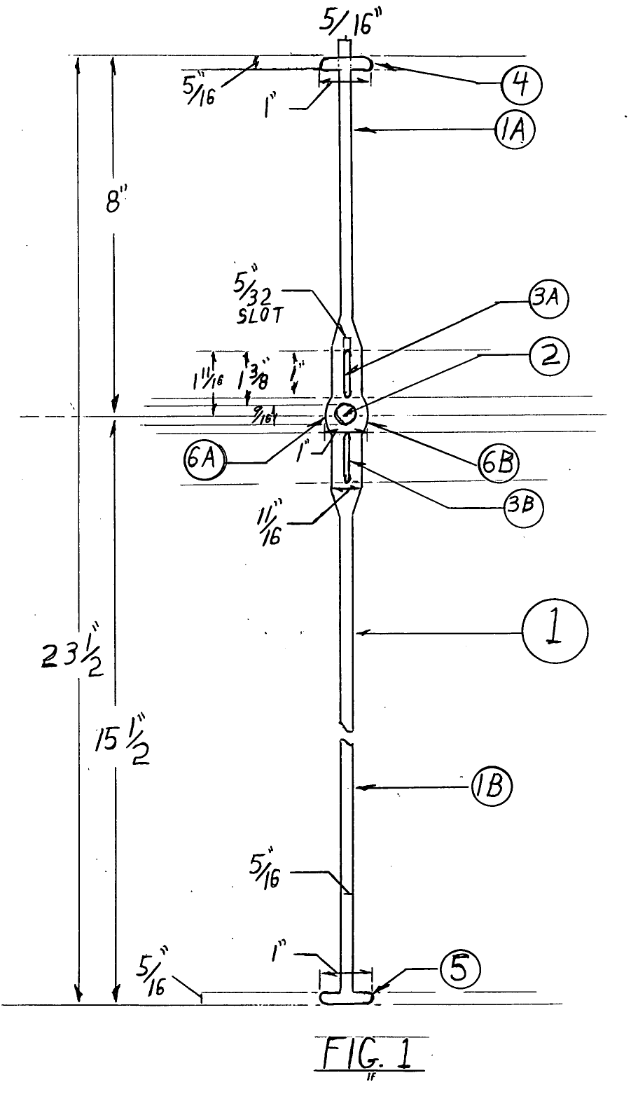

FIG. 1 is a front elevational view

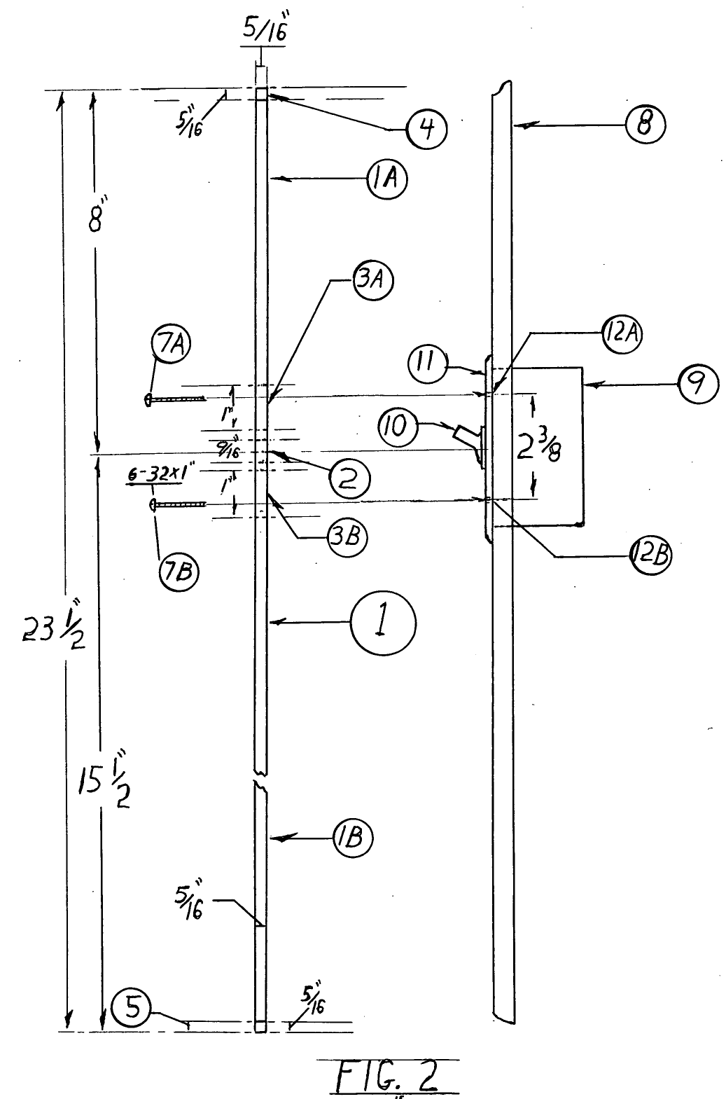

FIG. 2 is a side elevational view of actuating arm taken in the direction of arrow 1b in FIG. 1 and a perspective view of the wall 8 switch and the junction box 9 in the wall 8; the switch plate 11 in place in phantom and slot head screws exploded therefrom.

1 a light switch extender 1 1A shorter end of elongated actuating arm of 1 1B longer end of actuating arm of 1 2 hole 2 in 1 3A vertical slot of 1A 3B vertical slot of 1B 4 T shaped handle of 1A 5 T shaped handle of 1B 6 A; 6B flaired sides of 1 7A; 7B slot head screws for mounting through 3A 3B 8 wall 8 9 junction box 9 of 8 10 toggle switch 10 of 9 11 switch plate 11 of 9 12A 12B existing holes of 11

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A reach a lite for to help people turn a light switch on or off from below or above the switch, comprising:
means for added length both above and below the light switch;
means for providing 8 inches extra length for turning light switch on and off;
means for providing 15½ inches of extra length for turning on and off a light switch;
means for allowing the toggle switch of a lighted light switch to be seen;
means for allowing actuating arm to slide up and down;
means for allowing easier gripping when turning light on and off, rigidly connected to said means for providing 8 inches extra length for turning light switch on and off, and rigidly connected to said means for added length both above and below the light switch;
means for allowing easier gripping, rigidly connected to said means for allowing the toggle switch of a lighted light switch to be seen;
means for allowing easier gripping when using the center of actuating arm to turn light on and off, rigidly connected to said means for allowing easier gripping, and rigidly connected to said means for allowing actuating arm to slide up and down;
means for allowing easier gripping when using the center of the actuating arm to turn light on and off, rigidly connected to said means for allowing easier gripping, and rigidly connected to said means for providing 8 inches extra length for turning light switch on and off;
means for providing stability when inserted through slots in actuating arm, rigidly connected to said means for allowing actuating arm to slide up and down;
means for turning light on or off when actuating arm is moved up or down;
means for allowing the actuating arm to slide easily over the face of the light switch, rigidly connected to said means for turning light on or off when actuating arm is moved up or down;
means for holding the actuating arm when screws are in place, rigidly connected to said means for allowing the actuating arm to slide easily over the face of the light switch, and rigidly connected to said means for providing stability when inserted through slots in actuating arm; and
means for holding the actuating arm when screws are in place, rigidly connected to said means for allowing the actuating arm to slide easily over the face of the light switch.

2. The reach a lite in accordance with claim 1, wherein said means for added length both above and below the light switch comprises a dual purpose elongated actuating arm light switch extender.

3. The reach a lite in accordance with claim 1, wherein said means for providing 8 inches extra length for turning light switch on and off comprises a shorter side of arm.

4. The reach a lite in accordance with claim 1, wherein said means for providing 15½ inches of extra length for turning on and off a light switch comprises a longer side of arm.

5. The reach a lite in accordance with claim 1, wherein said means for allowing the toggle switch of a lighted light switch to be seen comprises a hole.

6. The reach a lite in accordance with claim 1, wherein said means for allowing actuating arm to slide up and down comprises a slot 3 (2 ea., a and b).

7. The reach a lite in accordance with claim 1, wherein said means for allowing easier gripping when turning light on and off comprises a t shaped handle short end t shaped handle.

8. The reach a lite in accordance with claim 1, wherein said means for allowing easier gripping comprises a long end t shaped handle.

9. The reach a lite in accordance with claim 1, wherein said means for allowing easier gripping when using the center of actuating arm to turn light on and off comprises a flared left side of extender.

10. The reach a lite in accordance with claim 1, wherein said means for allowing easier gripping when using the center of the actuating arm to turn light on and off comprises a flared right side of extender.

11. The reach a lite in accordance with claim 1, wherein said means for providing stability when inserted through slots in actuating arm comprises a slot head screw (2 ea.).

12. The reach a lite in accordance with claim 1, wherein said means for turning light on or off when actuating arm is moved up or down comprises a toggle switch.

13. The reach a lite in accordance with claim 1, wherein said means for allowing the actuating arm to slide easily over the face of the light switch comprises a flat surface switch plate.

14. The reach a lite in accordance with claim 1, wherein said means for holding the actuating arm when screws are in place comprises an existing top hole in switch plate.

15. The reach a lite in accordance with claim 1, wherein said means for holding the actuating arm when screws are in place comprises an existing bottom hole in switch plate.

16. A reach a lite for to help people turn a light switch on or off from below or above the switch, comprising:
a dual purpose elongated actuating arm light switch extender, for added length both above and below the light switch;
a shorter side of arm, for providing 8 inches extra length for turning light switch on and off;
a longer side of arm, for providing 15½ inches of extra length for turning on and off a light switch;
a hole, for allowing the toggle switch of a lighted light switch to be seen;
a slot 3 (2 ea., a and b), for allowing actuating arm to slide up and down;
a t shaped handle short end t shaped handle, for allowing easier gripping when turning light on and off, rigidly connected to said shorter side of arm, and rigidly connected to said light switch extender;
a long end t shaped handle, for allowing easier gripping, rigidly connected to said hole;
a flared left side of extender, for allowing easier gripping when using the center of actuating arm to turn light on and off, rigidly connected to said long end T shaped handle, and rigidly connected to said slot 3 (2 ea., a and b);
a flared right side of extender, for allowing easier gripping when using the center of the actuating arm to turn light on and off, rigidly connected to said long end T shaped handle, and rigidly connected to said shorter side of arm;
a slot head screw (2 ea.), for providing stability when inserted through slots in actuating arm, rigidly connected to said slot 3 (2 ea., a and b);
a toggle switch, for turning light on or off when actuating arm is moved up or down;
a flat surface switch plate, for allowing the actuating arm to slide easily over the face of the light switch, rigidly connected to said toggle switch;
an existing top hole in switch plate, for holding the actuating arm when screws are in place, rigidly connected to said switch plate, and rigidly connected to said slot head screw (2 ea.); and
an existing bottom hole in switch plate, for holding the actuating arm when screws are in place, rigidly connected to said switch plate.

17. The reach a lite as recited in claim 16, further comprising:
a wall, for holding the junction box in place on the inside and the switch plate mounted on the outside, rigidly connected to said switch plate.

18. The reach a lite as recited in claim 16, further comprising:
an electrical junction box junction box, for holding the light switch in place, rigidly connected to said wall.

19. The reach a lite as recited in claim 17, further comprising:
an electrical junction box junction box, for holding the light switch in place, rigidly connected to said wall.

20. A reach a lite for to help people turn a light switch on or off from below or above the switch, comprising:
a dual purpose elongated actuating arm light switch extender, for added length both above and below the light switch;
a shorter side of arm, for providing 8 inches extra length for turning light switch on and off;
a longer side of arm, for providing 15½ inches of extra length for turning on and off a light switch;
a hole, for allowing the toggle switch of a lighted light switch to be seen;
a slot 3 (2 ea., a and b), for allowing actuating arm to slide up and down;
a t shaped handle short end t shaped handle, for allowing easier gripping when turning light on and off, rigidly connected to said shorter side of arm, and rigidly connected to said light switch extender;
a long end t shaped handle, for allowing easier gripping, rigidly connected to said hole;
a flared left side of extender, for allowing easier gripping when using the center of actuating arm to turn light on and off, rigidly connected to said long end T shaped handle, and rigidly connected to said slot 3 (2 ea., a and b);
a flared right side of extender, for allowing easier gripping when using the center of the actuating arm to turn light on and off, rigidly connected to said long end T shaped handle, and rigidly connected to said shorter side of arm;
a slot head screw (2 ea.), for providing stability when inserted through slots in actuating arm, rigidly connected to said slot 3 (2 ea., a and b);
a wall, for holding the junction box in place on the inside and the switch plate mounted on the outside;
an electrical junction box junction box, for holding the light switch in place, rigidly connected to said wall;
a toggle switch, for turning light on or off when actuating arm is moved up or down;
a flat surface switch plate, for allowing the actuating arm to slide easily over the face of the light switch, rigidly connected to said toggle switch, and rigidly connected to said wall;
an existing top hole in switch plate, for holding the actuating arm when screws are in place, rigidly connected to said switch plate, and rigidly connected to said slot head screw (2 ea.); and
an existing bottom hole in switch plate, for holding the actuating arm when screws are in place, rigidly connected to said switch plate.
